(19) United States
(12) Patent Application Publication
(10) Pub. No.: US 2006/0132577 A1
(43) Pub. Date: Jun. 22, 2006

(54) Circuit topology for high-speed printed circuit board

(75) Inventors: Shou-Kuo Hsu, Tu-Cheng (TW); Jie Zhou, Shenzhen (CN); Xiang Zhu, Shenzhen (CN); Hong-Mei Hu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/291,756

(22) Filed: Dec. 1, 2005

(30) Foreign Application Priority Data
Dec. 4, 2004 (CN) 200410077284.0
Dec. 25, 2004 (CN) 200410091891.2

(51) Int. Cl. B41J 2/415

(52) U.S. Cl. 347/128

(57) ABSTRACT

A circuit topology for high-speed printed circuit board includes a driving circuit, and a number of receiving circuits. The driving circuit is mounted on the printed circuit board and coupled to a node via a transmission line. The receiving circuits receive signals transmitted from the driving circuit. Each receiving circuit is coupled to the node separately via a transmission line. Transmission line lengths between each of the receiving circuits and the node are substantially equal. The close the node is to the receiving circuits, the better the signal integrity. Using the circuit topology maintains signal integrity as the termination resistor does. It is of advantage that the circuit topology is simple to manufacture and very suitable for mass production.

### BACKGROUND OF THE INVENTION

1. Field of the Invention

The present invention relates to computer systems, and more particularly to a circuit topology for supporting the routing of signals in a printed circuit board.

2. Background

Signal integrity is an important factor to be taken into account when a printed circuit board (PCB) is designed. A well-designed PCB has an elevated on-off switching speed of integrated circuits, and a high density, compact layout of components. Parameters of the components and of the PCB substrate, a layout of the components on the PCB, and a layout of high-speed signal transmission lines all have an impact on signal integrity. In turn, proper signal integrity helps the PCB and an associated computer system to achieve stable performance. Impedance matching is considered as an important part of signal integrity. Therefore a characteristic impedance of a transmission line is designed to match an impedance of a load associated with that transmission line. If the characteristic impedance of the transmission line is mismatched with the impedance of the load, signals arriving at a receiving terminal are apt to be partially reflected, causing a waveform of the signals to distort, overshoot, or undershoot. Signals that reflect back and forth along the transmission line cause what is called “ringing.”

Referring to FIG. 7, a diagram illustrating a conventional circuit topology coupling a north bridge chipset to two memory slots is shown. A north bridge chipset 10 is coupled to a first memory slot 20 and a second memory slot 30 consecutively via a transmission line 12. The distance from the second slot 30 to the north bridge chipset 10 is longer than the distance from the first slot 20 to the north bridge chipset 10. A termination resistor 40 is coupled to the second memory slot 30 to eliminate signal reflections. However, employing the terminal resistor to depress the signal reflections increases the cost of the manufacture of the printed circuit.

What is needed, therefore, is a circuit topology which not only eliminates the signal reflections and maintains signal integrity, but also can be mass produced at a reasonable cost.

### SUMMARY

An exemplary circuit topology includes a driving circuit, and a plurality of receiving circuits. The driving circuit is mounted on a printed circuit board and coupled to a node via a transmission line. The plurality of receiving circuits receive signals transmitted from the driving circuit. Each of the receiving circuits is coupled to the node via a corresponding transmission line.

Transmission line lengths between each of the receiving circuits and the node are substantially equal. The close the node is to the receiving circuits, the better the signal integrity. Using the circuit topology maintains signal integrity as the termination resistor does. It is of advantage that the circuit topology is simple to manufacture and very suitable for mass production.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a circuit topology in accordance with a first preferred embodiment of the present invention, the circuit topology includes a north bridge chipset coupled to two memory slots;

FIG. 2 is a comparative graph showing address signal waveforms obtained using the circuit topologies of FIG. 1 and FIG. 7;

FIG. 3 is a comparative graph showing signal waveforms obtained using the circuit topologies of FIG. 1 and FIG. 7 when the north bridge chipset writes data to the memory slots;

FIG. 4 is a comparative graph showing signal waveforms obtained using the circuit topologies of FIG. 1 and FIG. 7 when the north bridge chipset reads data from the memory slots.

FIG. 5 is a block diagram of a circuit topology in accordance with a second preferred embodiment of the present invention;

FIG. 6 is a graph showing signal waveforms obtained using the circuit topology of FIG. 5; and

FIG. 7 is a block diagram of a conventional circuit topology.

### DETAILED DESCRIPTION OF THE EMBODIMENTS

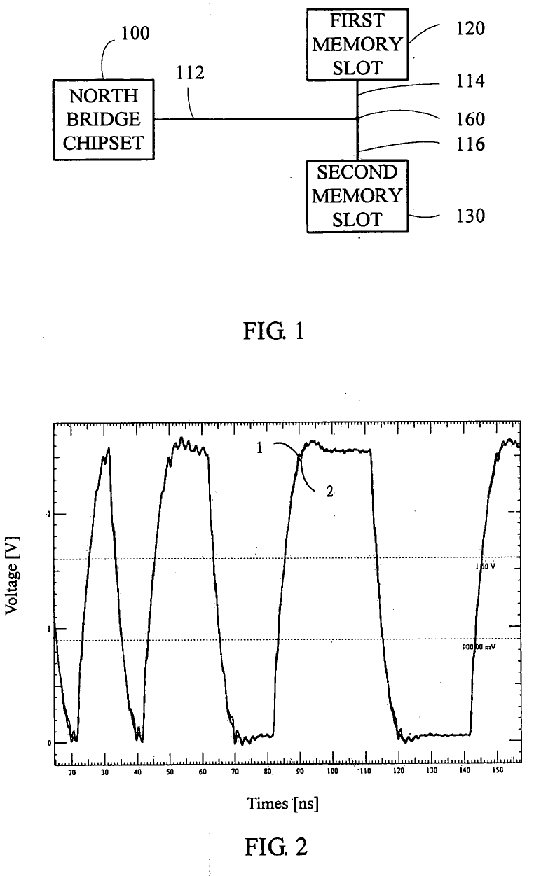

FIG. 1 shows a block diagram of a circuit topology in accordance with a first preferred embodiment of the present invention. A north bridge chipset 100 functioning as a driving circuit is coupled to a first memory slot 120 and a second memory slot 130, both of which function as a receiving circuit, respectively by a plurality of transmission lines 112, 114, and 116. The transmission lines 112, 114, and 116 are connected at a node 160. The north bridge chipset 100 is connected to the node 160 via the transmission line 112, the first memory slot 120 is connected to the node 160 via the transmission line 114, and the second memory slot 130 is connected to the node 160 via the transmission line 116. The circuit topology of FIG. 1 is a “T” type topology. In theory, the signal integrity is best when the length of the transmission lines 114 and 116 are equal to each other. In practice, however, the length of the transmission lines 114 and 116 may not be equal with each other due to the layout of other components on the PCB. The maximum allowable difference Lmax between each of the transmission lines 114 and 116 is calculated as follows:

$$L max = \frac{v}{T} ; \qquad ( 1 )$$

wherein Lmax denotes the maximum allowable difference between each of the transmission lines 114 and 116, v denotes the speed at which a signal is transmitted in the transmission line and T denotes the rising time of the signal. Signal integrity is maintained when an actual line length difference between the transmission lines 114 and 116 is less than or equal to Lmax.

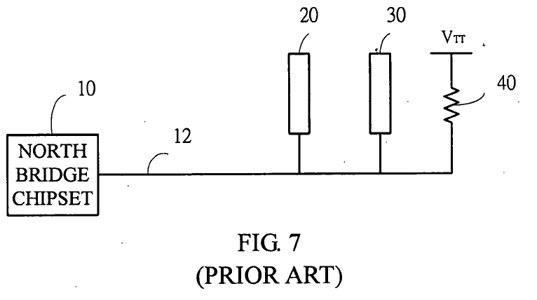

FIG. 2 is a comparative graph showing address signal waveforms obtained using the circuit topologies of FIG. 1 and FIG. 7. Line 1 denotes the signal waveform obtained using the circuit topology of FIG. 1, and line 2 denotes the signal waveform obtained using the circuit topology of FIG. 7. As shown in FIG. 2, the waveforms are nearly superposed upon each other. Using the “T” type circuit topology maintains signal integrity as the termination resistor of FIG. 7 does.

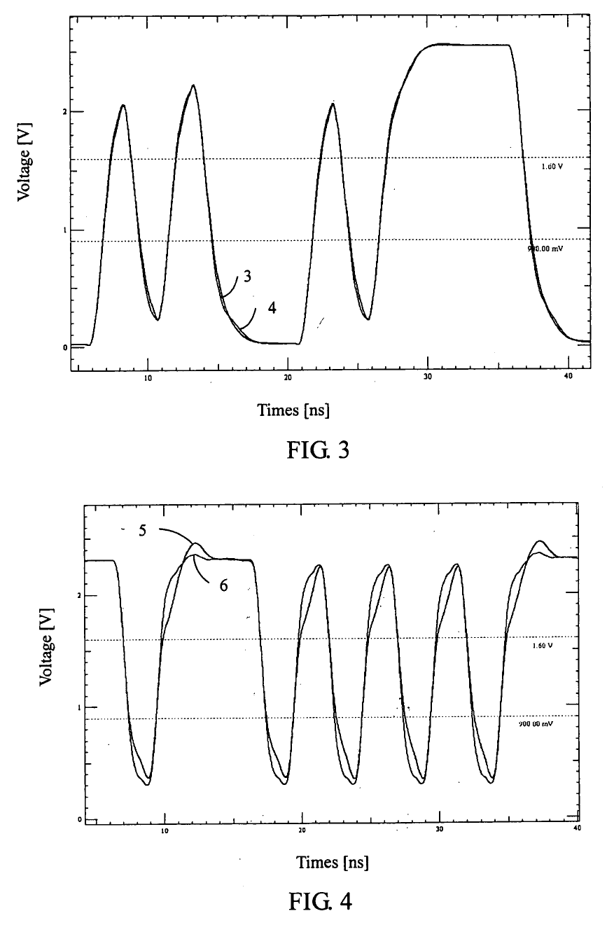

FIG. 3 is a comparative graph showing signal waveforms obtained using the circuit topologies of FIG. 1 and FIG. 7 when the north bridge chipset 10 writes data to the slots 120 and 130. Line 3 denotes the signal waveform obtained using the circuit topology of FIG. 1, and line 4 denotes the signal waveform obtained using the circuit topology of FIG. 7. As shown in FIG. 3, the waveforms are nearly superposed upon each other. Using the “T” type circuit topology maintains signal integrity as the terminal resistor of FIG. 7 does.

Referring to FIG. 4, a comparative graph shows signal waveforms obtained using the circuit topologies of FIG. 1 and FIG. 7 when the north bridge chipset 10 reads data from the slots 120 and 130. Line 5 denotes the signal waveform obtained using the circuit topology of the FIG. 1, and line 6 denotes the signal waveform obtained using the circuit topology of the FIG. 7. As shown in FIG. 4, though the waveforms are not a match, the difference is in a range that the circuit allows.

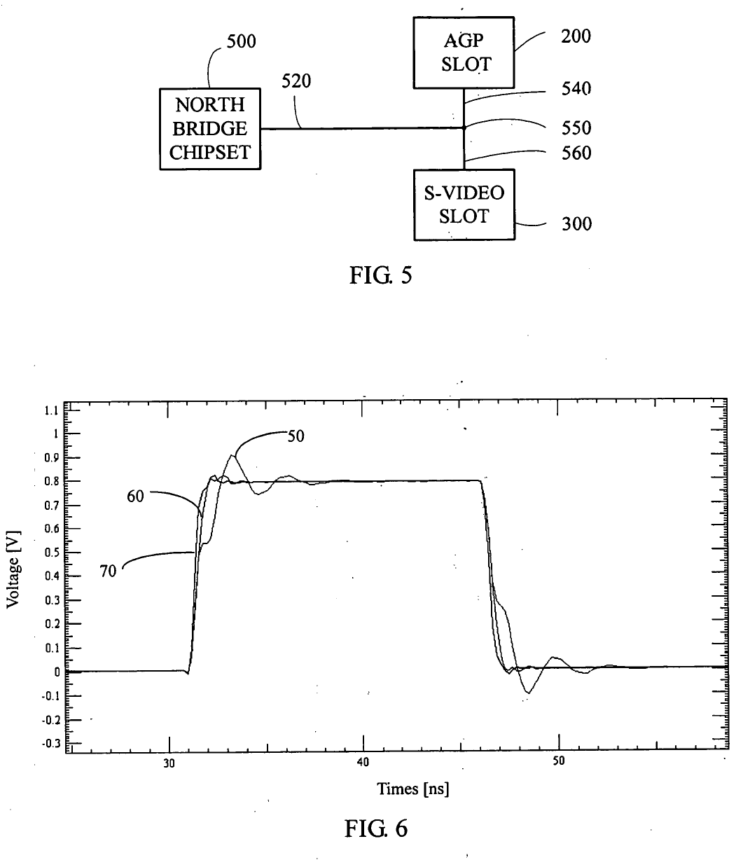

The “T” type circuit topology can be also applied to couple the north bridge chipset to an AGP slot and an S-video connector as shown in FIG. 5. A printed circuit board includes a north bridge chipset 500 coupled to an AGP slot 200 and an S-video connector 300 by a plurality of transmission lines 520, 540, and 560. The transmission lines 520, 540, and 560 are connected at a node 550. The north bridge chipset 500 is connected to the node 550 via the transmission line 520, the AGP slot 200 is connected to the node 550 via the transmission line 540, and the S-video connector 300 is connected to the node 550 via the transmission line 560.

FIG. 6 is a graph showing signal waveforms obtained using the circuit topology of FIG. 5. Line 70 denotes a signal waveform when there is no signal reflection. Line 50 denotes a signal waveform when the length of the transmission line 520 is 500 mils (1 mil=1×10⁻³ inch), and the length of the transmission lines 540 and 560 are 3000 mils. Line 60 denotes a signal waveform when the length of the transmission line 520 is 3000 mils, and the length of the transmission lines 540 and 560 are 500 mils. As shown in FIG. 5, the closes the node 550 is to the AGP slot 200 and the S-video connector 300, the better the signal integrity.

In the above-described circuit topology of the preferred embodiment of the present invention, the “T” type topology is applied to coupling the north bridge chipset 10 to the two memory slots 120 and 130 or to the AGP slot and the S-video connector. Other embodiments with one driving circuit coupled to a plurality of receiving circuits can use a star type circuit topology. The driving circuit is coupled to a node via a transmission line, and each of the receiving circuits is coupled to the node via a corresponding transmission line.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A circuit topology comprising:
a node;
driving circuit on a printed circuit board coupled to the node via a transmission line; and
a plurality of receiving circuits receiving signals transmitted from the driving circuit, each of the receiving circuits coupled to the node separately via a transmission line.

2. The circuit topology as claimed in claim 1, wherein transmission line lengths between each of the receiving circuits and the node are substantially equal.

3. The circuit topology as claimed in claim 1, wherein a maximum allowable difference Lmax between each of the transmission lines of the receiving circuits and the node is calculated according to the equation:
$$L max = \frac{v}{T} ,$$
and wherein v denotes a speed of a signal transmitted in the transmission lines, and T denotes a rising time of the signal.

4. The circuit topology as claimed in claim 1, wherein the node is close to the receiving circuits for achieving better signal integrity.

5. The circuit topology as claimed in claim 1, wherein the driving circuit is a north bridge chipset.

6. The circuit topology as claimed in claim 5, wherein the plurality of receiving circuits comprises two memory slots.

7. The circuit topology as claimed in claim 5, wherein the plurality of receiving circuits comprises an AGP slot and an S-video connector.

8. A layout method within a printed circuit board (PCB) comprising the steps of:
setting a driving circuit and a plurality of receiving circuits on the PCB;
coupling the driving circuit to a node via a transmission line; and
coupling each of the receiving circuits to the node separately via a transmission line.

9. The method as claimed in claim 8, wherein transmission line lengths between each of the receiving circuits and the node are substantially equal.

10. The method as claimed in claim 8, wherein a maximum allowable difference Lmax between each of the transmission lines of the receiving circuits and the node is calculated according to the equation:
$$L max = \frac{v}{T} ,$$
and wherein v denotes a speed of a signal transmitted in the transmission lines, and T denotes a rising time of the signal.

11. The method as claimed in claim 8, wherein the node is close to the receiving circuits for achieving better signal integrity.

12. The method as claimed in claim 8, wherein the driving circuit is a north bridge chipset.

13. The method as claimed in claim 12, wherein the plurality of receiving circuits comprises two memory slots.

14. The method as claimed in claim 12, wherein the plurality of receiving circuits comprises an AGP slot and a S-video connector.

15. A method for layout arrangement of a printed circuit board (PCB), comprising the steps of:
defining a first circuit on a PCB;
defining at least two second circuits on said PCB capable of performing signal interchange with said first circuit respectively and independently; and
coupling said first circuit to each of said at least two second circuits by means of a commonly-used electrical transmission line firstly and a respective branch electrical transmission line extending from an end of said commonly-used transmission line away from said first circuit secondly, said branch transmission line having a length of the shortest distance between said end of said commonly-used transmission line and said each of said at least two second circuits.

16. The method as claimed in claim 15, wherein said length of said branch transmission line for one of said at least two second circuits is substantially equal to said length for another of said at least two second circuits.
